(19) United States
(12) Patent Application Publication
(10) Pub. No.: US 2009/0191409 A1
(43) Pub. Date: Jul. 30, 2009

(54) Combined Wetting/Non-Wetting Element For Low and High Surface Tension Liquids

(76) Inventors: Steve Simon, Middletown, NJ (US); Victor A. Lifton, Bridgewater, NJ (US)

Correspondence Address: FISH & RICHARDSON P.C., P.O. BOX 1022, MINNEAPOLIS, MN, 55440-1022, US

(21) Appl. No.: 12/020,189

(22) Filed: Jan. 25, 2008

(51) Int. Cl. B32B 9/04; B05D 1/18; B05D 5/08; B05D 3/04; B05D 3/06; B29C 65/00

(52) U.S. Cl. 428/411.1; 427/331; 427/255.28; 427/271; 427/553; 427/535; 156/60

(57) ABSTRACT

A fluidic device includes a porous substrate, a non-wetting region extending through a first portion of the porous substrate from a first side of the substrate, in which the non-wetting region is impermeable to fluid transport, and a wetting region extending through a second portion of the porous substrate from a second side of the substrate, in which the wetting region is permeable to fluid transport.

### BACKGROUND

This disclosure relates to a combined wetting/non-wetting element for low and high surface tension liquids.

Microfluidic systems are important tools for research and development in many application areas including industrial engineering, bio/pharmaceuticals, food service, power and energy storage. In many cases, it is desirable to incorporate structures in the microfluidic systems that exhibit both non-wetting and wetting properties in order to facilitate control of fluid flow and reactions. Typically, such structures are developed using two separate and independent devices, in which one of the devices provides the non-wetting properties and the other device provides the wetting properties. The two devices then are incorporated into a single structure based on a desired functionality of the final microfluidic system.

### SUMMARY

The details of one or more implementations of the invention are set forth in the description below, the accompanying drawings and the claims.

For example, in one aspect, a fluidic device includes a porous substrate, a non-wetting region extending through a first portion of the porous substrate from a first side of the substrate, in which the non-wetting region is impermeable to fluid transport, and a wetting region extending through a second portion of the porous substrate from a second side of the substrate, in which the wetting region is permeable to fluid transport.

Some implementations include one or more of the following features.

In some implementations, the porous substrate includes fibers. The fibers can be woven.

In some cases, the porous substrate includes filaments.

In certain examples, the substrate includes a textile.

In some implementations, the substrate includes a filter.

In certain cases, the porous substrate includes micro-pores. In some cases, the substrate includes nano-pores.

In some examples, the non-wetting region includes a non-wetting coating. The non-wetting coating can include a self-assembled monolayer. Alternatively, or in addition, the non-wetting coating can include a fluoropolymer.

In certain implementations, the porous substrate includes at least one of a fiber, filament, pore, cavity or crevice and the non-wetting coating covers the surface of the fiber, filament, pore, cavity or crevice in the non-wetting region.

In some cases, the porous substrate is flexible.

In certain examples, the non-wetting region is hydrophobic or super-hydrophobic. In some cases, the non-wetting region is super-lyophobic.

In some implementations, the porous substrate includes a first porous material fixed to a second porous material.

In some cases, the wetting region is planar.

In another aspect, a fluidic device includes non-wetting regions extending along a thickness direction of the fluidic device, in which each non-wetting region is impermeable to fluid transport. The device further includes wetting regions extending along a thickness direction of the fluidic device, in which each wetting region is permeable to fluid transport.

In some implementations, the non-wetting regions and wetting regions are arranged in an alternating pattern.

In some cases, each of the non-wetting regions and wetting regions includes a porous substrate.

In certain examples, the thickness of each of the non-wetting regions is different from the thickness of each of the wetting regions.

In some examples, the non-wetting region includes a substrate selected from the group consisting of a hydrophobic substrate and a super-lyophobic substrate. In some cases, the wetting region includes a substrate selected from the group consisting of a hydrophobic substrate and a super-lyophobic substrate.

In another aspect, a fluidic device includes non-wetting regions, in which each non-wetting region has a different degree of fluid permeability.

In some implementations, the degree of fluid permeability is a minimum in a first non-wetting region on one side of the device and a maximum in a second non-wetting region on a second opposite side of the device, in which the fluid permeability increases in each of the regions from the first non-wetting region to the second non-wetting region.

In another aspect, a method of fabricating a fluidic device includes applying a non-wetting coating to a porous substrate and removing the non-wetting coating from the porous substrate to form a wetting region and a non-wetting region, in which the non-wetting region extends from a first side of the porous substrate through a first portion of the substrate and wherein the wetting region extends from a second side of the porous substrate through a second portion of the substrate.

In some cases, applying the non-wetting coating includes dip-coating the substrate in a non-wetting coating material.

In certain examples, applying the non-wetting coating includes chemical vapor deposition of the non-wetting coating on the porous substrate.

In certain implementations, applying the non-wetting coating includes self-assembly of the non-wetting coating on the porous substrate.

In some examples, removing the non-wetting coating includes exposing the porous substrate to ozone.

In some cases, removing the non-wetting coating includes exposing the porous substrate to ultraviolet light.

In some implementations, removing the non-wetting coating includes exposing the porous substrate to plasma.

In another aspect, a method of fabricating a fluidic device includes fixing a first porous substrate to a second porous substrate, in which each of the first and second porous substrates having a wetting region and a non-wetting region extending along a thickness direction of the fluidic device.

Other features will be readily apparent from the detailed description, drawings, and from the claims.

### BRIEF DESCRIPTION OF THE DRAWINGS

FIGS. 1A-1B illustrate examples of a fluidic device that includes a non-wetting region and a wetting region.

FIGS. 2A-2C illustrate a method of fabricating a fluidic device that include a non-wetting region and a wetting region.

FIGS. 3A-3C illustrate examples of a fluidic device that includes a non-wetting region and a wetting region.

FIG. 3D shows an example of fluidic device that includes a non-wetting region and a patterned wetting region.

FIG. 3E shows a top view of a porous non-wetting substrate that includes a planar wetting region.

FIGS. 4A-4C show example SEM images of glass fiber filters.

FIGS. 4D-4E show example SEM images of PVDF.

FIG. 5 shows an example image of a water droplet on a non-wetting region of a fluidic device.

FIG. 6 shows an example process of fixing a first polymeric filter to a second polymeric filter.

FIG. 7 illustrates an example of a fluidic device that includes several wetting substrates 26 and non-wetting substrates 28 fixed together in an alternating pattern.

FIG. 8 illustrates an example of a fluidic device that includes wetting regions and non-wetting regions having different thicknesses.

FIG. 9 shows an example of a fluidic device that includes super-hydrophobic filters stacked and arranged in an alternating pattern with super-lyophobic filters.

FIG. 10 shows an example of a fluidic device that includes multiple filters stacked together in which each filter has a different non-wetting coating.

### DETAILED DESCRIPTION

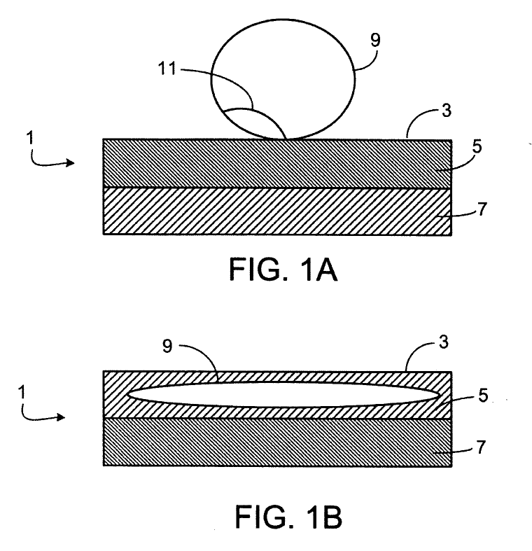

FIGS. 1A and 1B show an example of a discrete substrate 1 that exhibits both non-wetting and wetting properties. The substrate 1 can be used to manipulate low and high surface tension liquids including organic and aqueous liquids. As illustrated in FIGS. 1A and 1B, the substrate 1 includes two regions: a non-wetting first region 5 and an adjacent wetting second region 7. Due to the non-wetting nature of the first region 5, a liquid 9 placed on the surface of region 5 displays minimal affinity for spreading. For example, upon contact with the surface, the liquid 9 forms a spherically shaped droplet having a contact angle 11 greater than or equal to 90 degrees. The contact angle 11 of the droplet corresponds to the angle between the liquid-vapor and the liquid-solid interfaces when the substrate 1 and liquid 9 are in a vapor environment. In contrast, when the liquid 9 is placed on the wetting second region 7, the liquid 9 spreads out and is partially or completely absorbed by the second region 7, as shown in FIG. 1B. However, the presence of the adjacent non-wetting region 5 prevents the liquid from passing completely through the substrate 1 from the wetting region 7 to the opposite side of the substrate 1.

The non-wetting nature of region 5 can be characterized as hydrophobic, super-hydrophobic, super-lyophobic or as a combined hydrophobic/super-lyophobic region. A hydrophobic surface has minimal affinity for water, aqueous solutions and other high surface tension liquids. Accordingly, those liquids do not readily wet objects with hydrophobic properties. In some cases, the region 5 can be considered to be superhydrophobic, with the resulting liquid contact angle well above 90 degrees. An advantage of hydrophobic and superhydrophobic surfaces is that liquids placed on such surfaces can be manipulated and transported easily.

On the other hand, low surface tension liquids, which include, but are not limited to, kerosene, oils, hexane and various alcohols, tend to quickly spread and wet hydrophobic and superhydrophobic surfaces such that liquid handling is difficult. Instead, those liquids exhibit non-wetting properties on surfaces characterized as super-lyophobic. Super-lyophobic surfaces have minimal affinity for low surface tension liquids such that the liquids do not spread easily and can be relatively simple to manipulate.

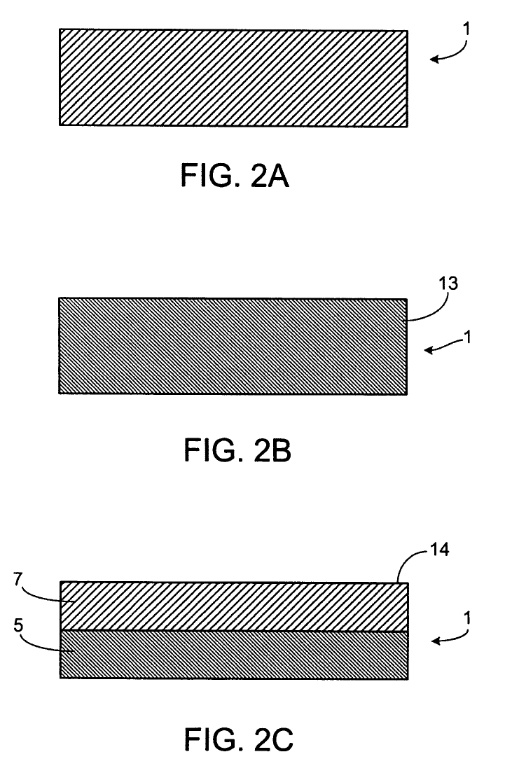

FIGS. 2A-2C show a method of fabricating the structure illustrated in FIGS. 1A-1B. Preferably, the substrate 1 is formed from a single porous and absorptive material that allows liquid to pass through it. For example, the substrate 1 can include a uniform composition of woven or non-woven materials, such as glass fiber filters, textiles and polymeric filters, that are composed of a network of natural or artificial filaments, e.g. fibers. In some cases, the substrate can be formed of a material having ordered or disordered micro-pores including, for example, polyvinylidene fluoride (PVDF). Porous microstructures can be fabricated by means of common processing techniques that include chemical etching and plasma etching or purchased from commercial vendors. In some cases, the substrate material is also flexible to provide enhanced durability.

As shown in FIG. 2B, the substrate 1 is covered with a non-wetting coating 13. Preferably, although not required, the coating 13 covers the entire substrate 1 including the surfaces of any fibers, filaments, crevices and pores. Examples of non-wetting coatings include polytetrafluoroethylene, fluoropolymers, CYTOP® material, and self-assembled monolayers (SAM). Depending on the non-wetting coating used, the level of hydrophobicity exhibited by the substrate 1 will differ. For example, a substrate coated with a SAM having fluorinated functional groups may appear to aqueous liquids as more non-wetting, i.e., hydrophobic, than a substrate coated with a SAM having a methyl functional group. The non-wetting coating 13 can be applied using, for example, dip-coating, spin-coating, chemical vapor deposition, spraying or self-assembly techniques. Other non-wetting coatings and methods for applying the coatings can be used as well.

In some implementations, the physical structure of the substrate material enhances the non-wetting features. For example, the fibers or pores of the substrate 1 can provide a micro and nano-scale surface roughness that, when can be combined with a non-wetting coating, exhibits super non-wetting properties. A material that exhibits super non-wetting properties is extremely difficult to wet. In many cases, the contact angle of a liquid on the surface of a super non-wetting material exceeds 120 degrees.

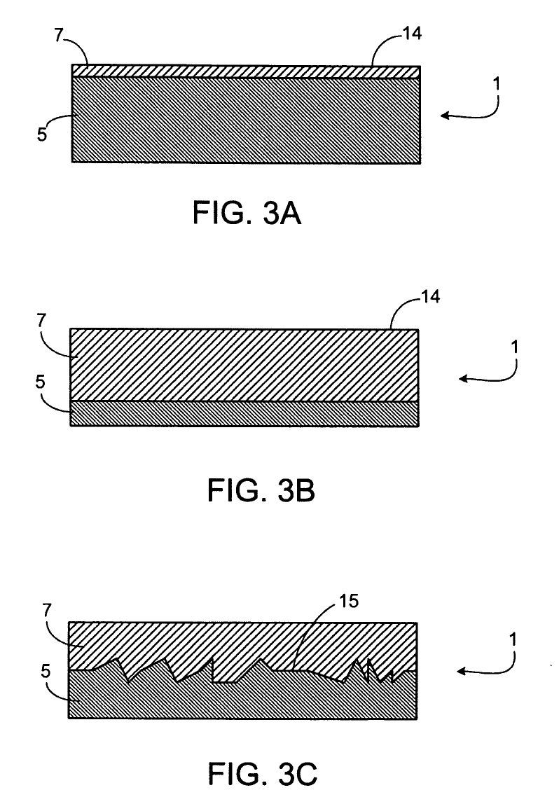

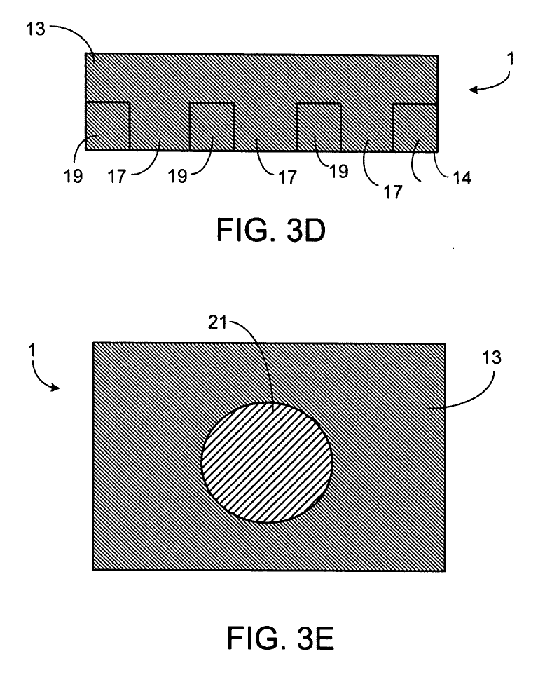

After the non-wetting coating 13 has been applied, the coating 13 is partially removed from the substrate 1 (see FIG. 2C) to form a first non-wetting region 5 and a second wetting region 7. Removal of the non-wetting coating 13 can be accomplished by exposing a side 14 of the substrate 1 to ozone, ultraviolet light and plasmas. Other coating removal methods may be applied as well. In the region of the substrate 1 where the non-wetting coating is removed, the coating 13 is eliminated from the surface of any fibers, filaments, crevices or pores to which it is attached. In some cases, the removal process also oxidizes the surface of the substrate material such that it exhibits wetting properties, i.e., liquids will tend to wet the surface. Depending on the process conditions under which the non-wetting coating is removed, the depth to which the wetting properties extend in the substrate 1 can be varied. For example, as shown in FIG. 3A, exposing the side 14 of substrate 1 to an oxygen plasma for a few seconds at low power may create a shallow wetting region 7 in the substrate 1. The remaining non-wetting region 5 of the substrate 1 is unaffected. Alternatively, the side 14 can be exposed to a high power plasma for several minutes such that the wetting region 7 extends beyond half the thickness of the substrate 1, as illustrated in FIG. 3B. Accordingly, it is possible to fabricate a bi-layered wetting/non-wetting material in which the thickness of the wetting and non-wetting regions can be controlled.

As a result of the non-uniformity of some coating removal methods, the depth of a boundary 15 between the wetting and non-wetting regions can be uneven or circuitous along the length and width of the substrate 1 as shown in FIG. 3C.

In some implementations, a mask can be applied to the side 14 of substrate 1 prior to exposing the device to a plasma. During subsequent application of the plasma, the regions of side 14 covered by the mask will retain the non-wetting coating 13. In contrast, the regions of side 14 that are exposed to the plasma through the mask will have the coating 13 removed. As a result, a variety of non-wetting/wetting patterns can be formed in the substrate 1 based on the design of the mask. For example, FIG. 3D shows a porous substrate 1 having a non-wetting coating 13 in which the bottom side 14 of the substrate 1 was exposed to a plasma through a shadow mask. As evident in the figure, portions 17, which were covered by the shadow mask, retain a non-wetting coating. In contrast, portions 19 that were exposed to the plasma through the shadow mask have had the coating 13 removed. Accordingly, the plasma exposed portions 19 have a higher affinity for liquids and exhibit preferentially wetting properties. In addition to shadow masks, other masks, such as photosensitive resists, can be used.

As explained above, the depth to which the non-wetting coating is removed can be controlled based on the total amount of time the substrate is exposed to a plasma. In some cases, the plasma exposure is so brief that only a thin layer of the non-wetting coating 13 is removed. For example, FIG. 3E shows a top view of a substrate 1 having a non-wetting coating 13 in which the substrate is exposed to a plasma through a shadow mask for a very brief period, on the order of half a second. The mask is designed to have a single hole in the center. As a result of the brief plasma exposure, only a very thin amount of the non-wetting coating 13 is removed from a region 21 of the substrate 1 that is underneath the mask hole. A liquid subsequently placed on the substrate 1 spreads out in the wetting region 21 but is confined at boundaries where the non-wetting coating 13 remains. Given that the coating 13 has only been removed in a very thin layer during the brief plasma exposure, the liquid will not be absorbed by the substrate 1. Accordingly, the wetting region is confined to a plane of the substrate. The plasma exposure time and power required to remove a thin layer of the non-wetting coating 13 can vary depending on the type of coating used.

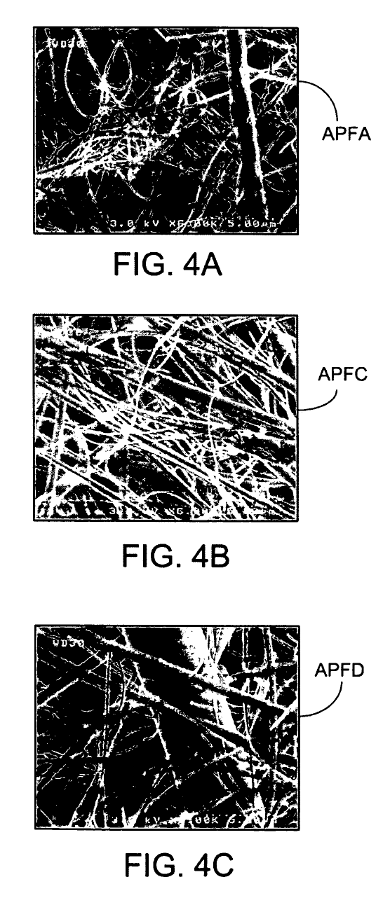

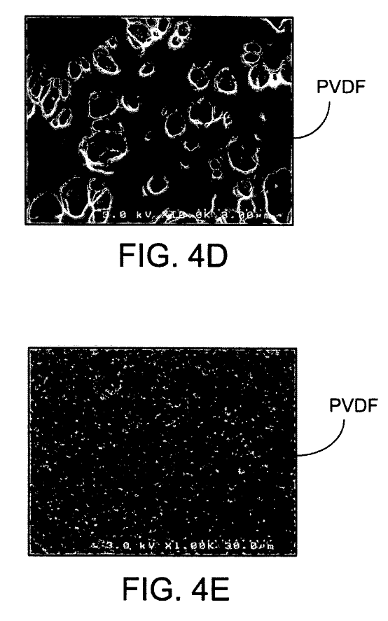

FIGS. 4A-4C show example scanning electron microscope (SEM) images corresponding to glass fiber filter substrate material APFA, APFC and APFD, respectively. The substrates shown in FIGS. 4A-4C are manufactured by Millipore Corporation of Billerica, Mass. FIGS. 4D-4E show example SEM images of PVDF substrate material taken at different magnifications.

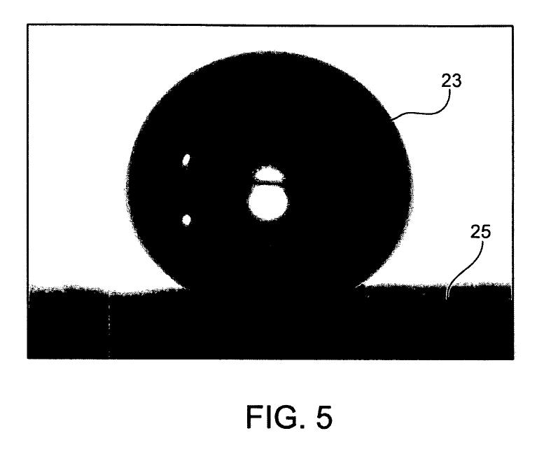

A bi-layer hydrophilic/hydrophobic structure was successfully prepared with the APFC glass fiber filter used as the core substrate material. The substrate was coated with a self-assembled monolayer that included chlorinated silanes. One side of the substrate was exposed to an oxygen plasma at 200 W for 30 seconds, such that the coating was removed and the surface of the substrate readily absorbed liquids. The opposite side of the substrate, in contrast, retained the super-hydrophobic properties. An example of the bi-layer structure including a water droplet 23 on the hydrophobic surface 25 is shown in FIG. 5.

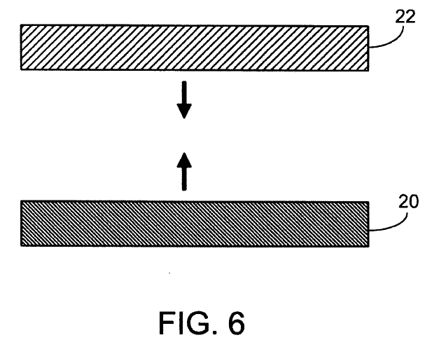

In some implementations, the substrate is formed by fixing together two separate and discrete porous materials as opposed to using a single substrate material. In the example shown in FIG. 6, a first polymeric filter 20 is covered with a conformal non-wetting coating. The coating can be applied to the filter 20 in a manner similar to the process described with reference to FIG. 2B. As indicated by the arrows in FIG. 6, the first polymeric filter 20 then is fixed to a second polymeric filter 22 that does not include a non-wetting coating. Various methods of adhesion may be used to fix the substrates together. For example, in some implementations, the first substrate can bond with the second substrate by means of Van der Waals forces. If there is a large contact area between the two substrates, the total Van der Waals force can be high, providing significant adhesion strength. In another example, a liquid can be applied between the substrates such that, as the liquid dries, capillary forces pull the substrates closer together and increase the contact area where Van der Waals bonding can occur. Alternatively, or in addition, fibers from the first filter 20 and second filter 22 can interlock to hold the materials together, adhering them in a manner that is similar to the use of VELCRO® tape.

In contrast to the first polymeric filter 20, the second polymeric filter 22 is not covered with a non-wetting coating 13. Rather, the filter 22 is kept free of contamination and coating layers so as to maintain hydrophilic wetting properties. Accordingly, when the first and second filters 20, 22 are fixed together, a liquid droplet 13 placed on the surface of the first filter 20 is precluded from penetrating into the second filter 22 as a result of the non-wetting characteristics of the first filter 20. In some implementations, the first filter 20, the second filter 22 or both filters are replaced with substrates having micro-pores or nano-pores, in which the average diameter of a pore is in the range of several nanometers to several thousand microns.

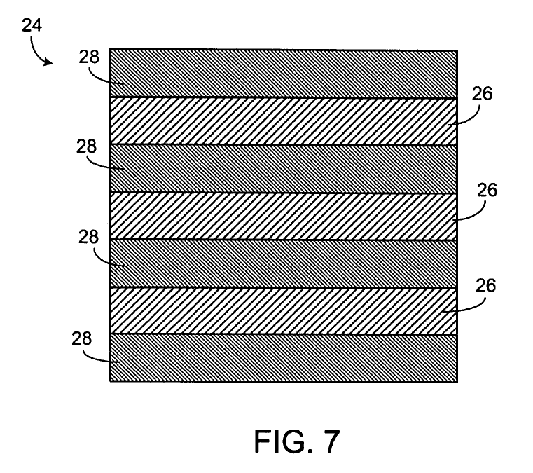

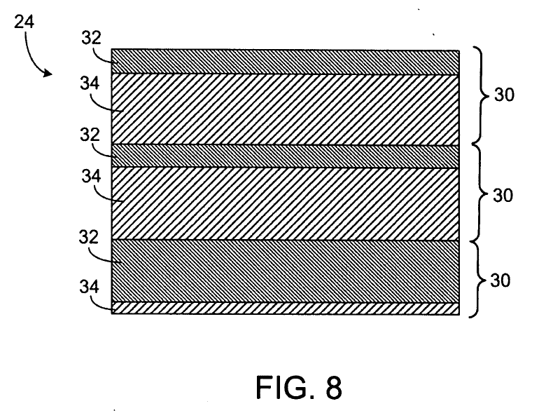

In some implementations, multiple wetting and non-wetting regions can be arranged through the thickness of the device. For example, as shown in FIG. 7, a fluidic device 24 is composed of several wetting substrates 26 and non-wetting substrates 28 that have been fixed together in an alternating pattern. Accordingly, it is possible to trap liquids in the wetting regions of the device 24 and between the non-wetting substrates 28. Alternatively, or in addition, multiple non-wetting substrates 28 can be fixed in series to create thicker non-wetting regions in the device 24. Similarly, multiple wetting substrates 26 can be fixed together to create thicker wetting regions. Extending the wetting region in this manner allows, for example, greater amounts of liquid to be stored or trapped in the device 24. In some cases, the device 24 can include multiple substrates 30 fixed together in which each substrate 30 is modified to include both a non-wetting region 32 as well as a wetting region 34 having predefined thicknesses as shown in FIG. 8. As a result, the thickness of the wetting region or non-wetting region is not limited to the thickness of the substrate.

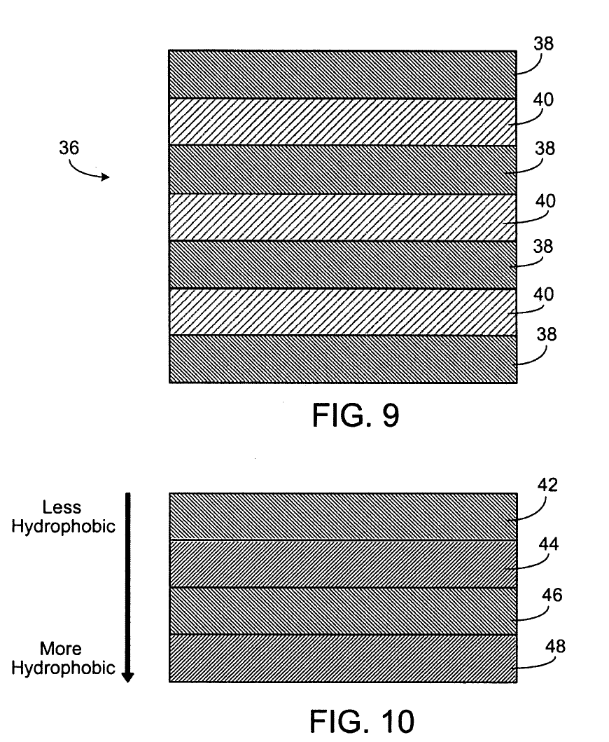

It also is possible to fabricate a non-wetting structure such that it includes both hydrophobic and super-lyophobic properties. For example, FIG. 9 shows a device 36 that includes filters 38 with super-hydrophobic properties stacked and arranged in an alternating pattern with filters 40 having super-lyophobic properties. Liquids having low surface tension, such as 1-butanol (surface tension equal to 26.2 mN/m) or 1-octanol (surface tension equal to 27.6 mN/m), would pass directly through the super-hydrophobic top filter 38 of the stack. Thus, the top filter 38 appears to low-surface tension liquids as a wetting region, even though it is super-hydrophobic. Upon reaching the super-lyophobic filter 40 located beneath the top stage, the low surface tension liquids would stop spreading and would be contained by the super-lyophobic filter. On the other hand, high-surface tension liquids, such as water (surface tension equal to 72.0 mN/m), would not pass through the top super-hydrophobic filter 38. Similarly, the super-lyophobic filter 40 can appear to some liquids as a wetting region.

By varying the level of non-wetting characteristics in each stage of the stack (e.g., by increasing or decreasing the level of hydrophobicity), it is possible to fabricate a structure that separates liquids based on surface tension. For example, FIG. 10 shows multiple filters (42, 44, 46, 48) stacked together in which each filter includes a different non-wetting coating. The filters are arranged based on an increasing level of hydrophobicity exhibited by the filter coating, such that low-surface tension liquids would pass through the top filter 42 (having a low level of hydrophobicity) but not through the bottom filter 48 (having a high level of hydrophobicity). Filters with super-lyophobic properties can be used as well to increase the liquid selectively of the filter stack.

A number of implementations have been described. Nevertheless, it will be understood that various modifications may be made without departing from the spirit and scope of the invention. Other implementations also are within the scope of the claims.

What is claimed is:

1. A fluidic device comprising:
a porous substrate;
a non-wetting region extending through a first portion of the porous substrate from a first side of the substrate, wherein the non-wetting region is impermeable to fluid transport; and
a wetting region extending through a second portion of the porous substrate from a second side of the substrate, wherein the wetting region is permeable to fluid transport.

2. The fluidic device according to claim 1 wherein the porous substrate comprises fibers.

3. The fluidic device according to claim 2 wherein the fibers are woven together.

4. The fluidic device according to claim 1 wherein the porous substrate comprises filaments.

5. The fluidic device according to claim 1 wherein the porous substrate comprises a textile.

6. The fluidic device according to claim 1 wherein the porous substrate comprises a filter.

7. The fluidic device according to claim 1 wherein the porous substrate comprises micro-pores.

8. The fluidic device according to claim 1 wherein the porous substrate comprises nano-pores.

9. The fluidic device according to claim 1 wherein the non-wetting region comprises a non-wetting coating.

10. The fluidic device according to claim 9 wherein the non-wetting coating comprises a self-assembled monolayer.

11. The fluidic device according to claim 9 wherein the non-wetting coating comprises a fluoropolymer.

12. The fluidic device according to claim 9 wherein the porous substrate comprises at least one of a fiber, filament, pore, cavity or crevice and wherein the non-wetting coating covers the surface of the fiber, filament, pore, cavity or crevice in the non-wetting region.

13. The fluidic device according to claim 1 wherein the porous substrate is flexible.

14. The fluidic device according to claim 1 wherein the non-wetting region is hydrophobic.

15. The fluidic device according to claim 1 wherein the non-wetting region is super-lyophobic.

16. The fluidic device according to claim 1 wherein the porous substrate comprises a first porous material fixed to a second porous material.

17. The fluidic device according to claim 1 wherein the wetting region is planar.

18. A fluidic device comprising:
a plurality of non-wetting regions extending along a thickness direction of the fluidic device, wherein each non-wetting region is impermeable to a fluid; and
a plurality of wetting regions extending along the thickness direction of the fluidic device, wherein each wetting region is permeable to the fluid.

19. The fluidic device according to claim 18 wherein the plurality of non-wetting regions and wetting regions are arranged in an alternating pattern.

20. The fluidic device according to claim 18 wherein each of the non-wetting regions and wetting regions comprises a porous substrate.

21. The fluidic device according to claim 18 wherein the thickness of each of the non-wetting regions is different from the thickness of each of the wetting regions.

22. The fluidic device according to claim 18 wherein the non-wetting region includes a substrate selected from the group consisting of a hydrophobic substrate and a super-lyophobic substrate.

23. The fluidic device according to claim 18 wherein the wetting region includes a substrate selected from the group consisting of a hydrophobic substrate and a super-lyophobic substrate.

24. A fluidic device comprising:
a plurality of non-wetting regions wherein each non-wetting region has a different degree of fluid permeability.

25. The fluidic device according to claim 24 wherein the degree of fluid permeability is a minimum in a first non-wetting region on one side of the device and a maximum in a second non-wetting region on a second opposite side of the device and wherein the fluid permeability increases from the first non-wetting region to the second non-wetting region.

26. A method of fabricating a fluidic device comprising:
applying a non-wetting coating to a porous substrate; and
removing the non-wetting coating from the porous substrate to form a wetting region and a non-wetting region,
wherein the non-wetting region extends from a first side of the porous substrate through a first portion of the substrate and wherein the wetting region extends from a second side of the porous substrate through a second portion of the substrate.

27. The method according to claim 26 wherein applying the non-wetting coating comprises dip-coating the substrate in a non-wetting coating material.

28. The method according to claim 26 wherein applying the non-wetting coating comprises chemical vapor deposition of the non-wetting coating on the porous substrate.

29. The method according to claim 26 wherein applying the non-wetting coating comprises self-assembly of the non-wetting coating on the porous substrate.

30. The method according to claim 26 wherein removing the non-wetting coating comprises exposing the porous substrate to ozone.

31. The method according to claim 26 wherein removing the non-wetting coating comprises exposing the porous substrate to ultraviolet light.

32. The method according to claim 26 wherein removing the non-wetting coating comprises exposing the porous substrate to plasma.

33. A method of fabricating a fluidic device comprising:
fixing a first porous substrate to a second porous substrate, wherein each of the first and second porous substrates having a wetting region and a non-wetting region extending along a thickness direction of the fluidic device.
